(19) United States
(12) Patent Application Publication
(10) Pub. No.: US 2021/0093924 A1
(43) Pub. Date: Apr. 1, 2021

(54) POOL NOODLE CAP

(71) Applicant: Tammi Brown, Lebanon, TN (US)

(72) Inventor: Tammi Brown, Lebanon, TN (US)

(21) Appl. No.: 16/589,697

(22) Filed: Oct. 1, 2019

(51) Int. Cl. A63B 31/10

(52) U.S. Cl. CPC A63B 31/10

(57) ABSTRACT

An illustrated view of an exemplary pool noodle cap for protecting a pool noodle when not being utilized. The pool noodle cap is useful for preventing debris, bugs, mice and snakes from entering into any open spaces of the pool noodle. Further, the pool noodle cap is useful for a person storing the pool noodles so when summer comes, they can be instantly ready for a pool or beach without having to wash out the pool noodle or check for snakes, mice and bugs.

### FIELD OF THE INVENTION

This invention relates to pool noodles. More particularly, it relates to storing devices for pool noodles.

### BACKGROUND

A recreational vehicle, often abbreviated as RV, is a motor vehicle or trailer which includes living quarters designed for accommodation. Types of RVs include motorhomes, campervans, caravans (also known as travel trailers and camper trailers), fifth-wheel trailers, popup campers and truck campers.

A pool noodle is a cylindrical piece of buoyant polyethylene foam, sometimes hollow. Noodles are used by people of all ages while swimming.

Pool noodles are useful when learning to swim, for floating, for rescue reaching, in various forms of water play, and for aquatic exercise. The most common dimensions are about 160 centimeters (63 in) in length and 7 centimeters (2.8 in) in diameter. The pool noodle is also used for people who experience difficulties in swimming.

The pool noodle is often used to protect sharp edges and corners.

There are several pool noodle connectors on the market. One connector is a piece of pipe made out of foam, slightly larger than a pool noodle so that it can connect two pool noodles by encasing the end of each. There are several other connector made of food grade polypropylene and manufactured in Australia and the USA.

This noodle connector comes in the form of an erector set that is screwed into the cavity or center of the foam noodle and attaches to a 6-sided noodle connector. This allows larger structures to be built from pool noodles. There exist at least two-, four- and six-hole foam connectors and a variety of polypropylene connector parts that enable users to build all types of structures and designs.

One of the problems with pool noodles is that when they are stored dirt, mud, bugs and varmints can gather in the cavity or center of the pool noodles. When the pool noodles are retrieved for use, the pool noodle must be cleaned and potentially a varmint such as a snake, mouse, etc. may appear from the cavity of the pool noodle. Further, damage to the pool noodle inside of the cavity may occur from varmints and the like eating or scratching the cavity walls. Further, the varmints building a nest or taking shelter in the cavity of the pool noodle may defecate or urinate which contain bacteria and other matter which can be harmful to people.

In light of the foregoing, there is a need for a device that can seal the cavity of a pool noodle from varmints, dirt, trash, mud and the like. The device must be easy to use and reusable across multiple pool noodles as well as configured to be devised to fit each of the common size pool noodles without compromising structural integrity or final aesthetic qualities.

### BRIEF DESCRIPTION OF THE DRAWINGS

FIG. 1A is an illustrated view of an exemplary pool noodle cap.

FIG. 1B is an illustrated side view of the pool noodle cap shown in FIG. 1A.

FIG. 1C is an illustrated bottom view of the pool noodle cap shown in

FIG. 1A.

FIG. 2A is an illustrated end view of pool noodle.

FIG. 2B is an illustrated view of the end of the pool noodle shown in FIG. 2A with the exemplary pool noodle cap shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

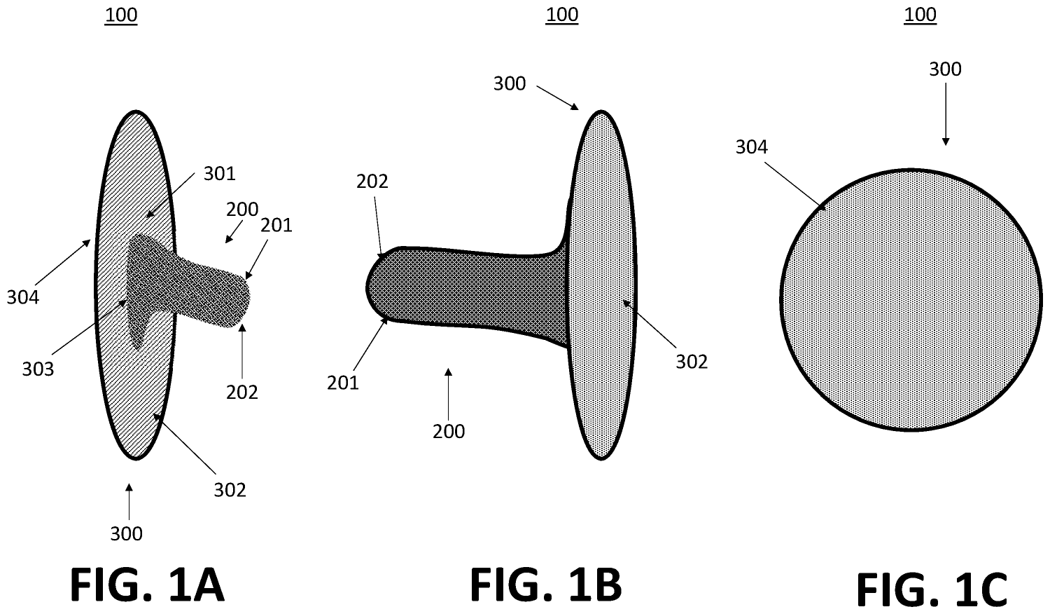

Referring to FIG. 1A, FIG. 1B and FIG. 1C, an illustrated view of an exemplary pool noodle cap 100 for protecting a pool noodle when not being utilized. The pool noodle cap 100 is useful for preventing debris, bugs, mice and snakes from entering into any open spaces of the pool noodle. Further, the pool noodle cap 100 is useful for a person storing the pool noodles so when summer arrives, they can be instantly ready for a pool or beach without having to wash out the pool noodle or check for snakes, mice and bugs.

The pool noodle cap 100 has a plug 200 and a cover 300. The pool noodle cap 100 is preferably made of a single cast, however the plug 200 and the cover 300 may be cast separately and coupled after casting. When the pool noodle cap 100 is not made in a single cast, then the plug 200 is securely coupled to a middle portion 301 of a top 302 of the cover 300 of the pool noodle cap 100 by a coupling device 303. The coupling device 303 is preferably an epoxy adhesive, however other types of coupling devices are hereby contemplated, including, but not limited to, screws, Velcro® straps, etc. A bottom 304 of the cover 300 is substantially flat.

The cover 300 is preferably three-eighths (⅜) inches in diameter, however other diameters are hereby contemplated, including, but not limited to, one-half (0.5) inch, one-fourth (0.25) inch, etc. The pool noodle cap 100 is preferably made of a hard-plastic material, however other materials are hereby contemplated, including, but not limited to, rubber, poly-vinyl chloride (PVC), etc. The cover 300 is preferably a round shape, however other shapes are hereby contemplated, including, but not limited to, square, oblong, etc. The cover 300 is preferably made of a hard-plastic material, however other materials are hereby contemplated, including, but not limited to, rubber, poly-vinyl chloride (PVC), etc.

The plug 200 is preferably made of a hard-plastic material, however other materials are hereby contemplated, including, but not limited to, rubber, poly-vinyl chloride (PVC), etc. The plug 200 is preferably a cylindrical shape, however other shapes are hereby contemplated including, but not limited to, square, rectangular, oblong, etc. The plug 200 is preferably one and one-half (1.5) inches in length, however other lengths are hereby contemplated, including, but not limited to, one and one-fourth (1.25) inches, one and three-fourths (1.75) inches, etc. The plug 200 has a first end 201 and a tip 202. The tip 202 of the plug 200 is preferably a rounded shape, however other shapes are hereby contemplated, including, but not limited to, geometric, triangle, etc.

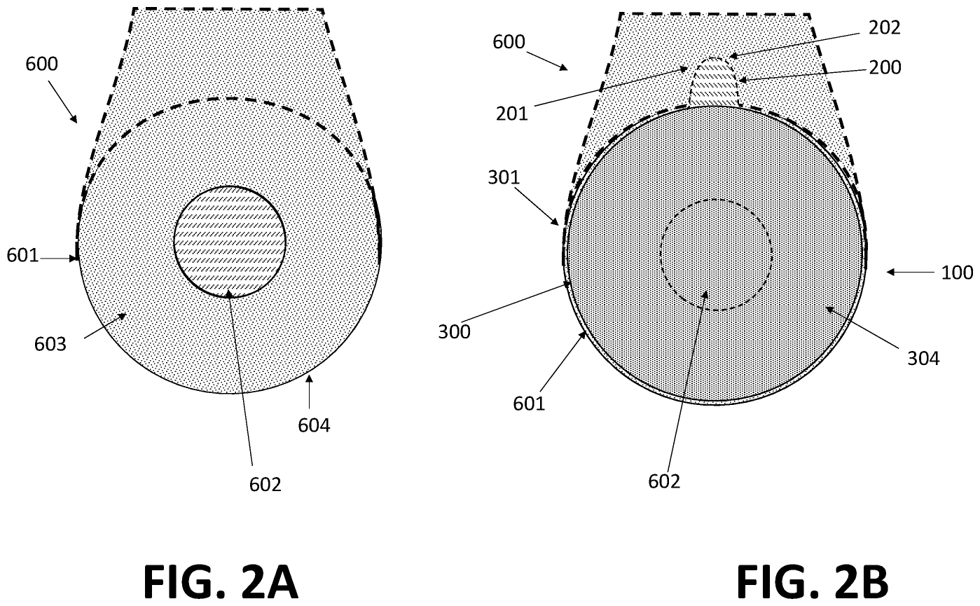

Moving now to FIG. 2A and FIG. 2B, an illustrated view of the exemplary pool noodle cap 100 in use with a pool noodle 600 is presented.

The pool noodle 600 is first shown from a first end 601 of the pool noodle 600 perspective. The pool noodle 600 further has a second end (not shown) that is substantially the same as the first end 601 of the pool noodle 600 such that the use of the pool noodle cap 100 coupling to the first end 601 of the pool noodle 600 teaches a same teaching for the second end of the pool noodle 600.

The first end 601 of the pool noodle 600 has a cavity 602, a wall 603 and an outside 604. The cavity 602 of the first end 601 of the pool noodle 600 is typically three-eighths (⅜) inches in diameter, however other diameters may also be used, including, but not limited to, one-fourth (0.25) inch, one-half (0.5) inch, etc. The cavity 602 extends from the first end 601 of the pool noodle 600 to the second end of the pool noodle 600. The first end 601 is typically offered in three (3) sized, those being a diameter of two and one-fourth (2.25) inch, two and one-half (2.5) inch and three (3) inch, although other diameters are further contemplated by this teaching. Therefore, the cover 300 has a diameter that is consistent with the width of the pool noodle 600.

In FIG. 2B, the first end 601 of the pool noodle 600 is shown with the pool noodle cap 100 installed. The plug 200 (see FIG. 1A) is inserted into the cavity 602 of the pool noodle 600. The pool noodle cap 100 is pushed into the cavity 602 of the pool noodle 600 until the bottom 301 of the cover 300 is substantially against the first end 601 of the pool noodle 600.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A pool noodle cap for protecting a pool noodle when stored, the cap comprising:
a plug, the plug being securely coupled to a cavity of the pool noodle; and
a cover, the cover having a top and a bottom, wherein the plug being securely coupled to substantially near a middle portion of the top of the cover, and wherein being coupled to a first end of the pool noodle.

2. The cap of claim 1, wherein the cavity of the pool noodle having a diameter being three-eighths (⅜) inches.

3. The cap of claim 1, wherein the plug having a first end, wherein the first end having a tip.

4. The cap of claim 4, wherein the tipoff being a rounded shape.

5. The cap of claim 1, wherein the plug being cylindrical in shape.

6. The cap of claim 1, wherein the plug having a length being one and one-half (1.5) inches.

7. The cap of claim 1, wherein the cover having a diameter being three-eights (⅜) inch.

8. The cap of claim 1, wherein the cover being made of a plastic material.

9. The cap of claim 1, wherein the plug being made of a plastic material.

10. The cap of claim 1, wherein the cap being made of a single casting.

11. The cap of claim 1, wherein the bottom of the cover being a flat shape.
